(19) United States
(12) Patent Application Publication
(10) Pub. No.: US 2013/0130728 A1
(43) Pub. Date: May 23, 2013

(54) REMOTE ACCESS OF INFORMATION STORED IN A MOBILE PHONE

(71) Applicant: Usha Rani Bendrum, Bangalore (IN)

(72) Inventor: Usha Rani Bendrum, Bangalore (IN)

(73) Assignee: Oracle International Corporation, Redwood Shores, CA (US)

(21) Appl. No.: 13/299,363

(22) Filed: Nov. 18, 2011

(51) Int. Cl. H04W 4/14

(52) U.S. Cl. 455/466

(57) ABSTRACT

A device, accessible by a network interface based on cellular telephony, receives an SMS (short messaging service) message, and in response causes information stored on a mobile phone to be transmitted to a server system. A user can thereafter access the data by interfacing with the server system using protocols such as IP. In an embodiment, the device is the mobile phone, which on receipt of the SMS message transmits the data to a server system. In another embodiment, the device is a server system, which initiates communication with the mobile phone to cause the data to be transferred.

### BACKGROUND OF THE INVENTION

1. Technical Field

The present disclosure relates to cellular telephony and more specifically to remote access of information stored in a mobile phone.

2. Related Art

A mobile phone refers to a device which permits voice calls based on cellular telephony. As is well known, in cellular telephony, base stations are provided covering corresponding cells, and a mobile phone typically has a first/last hop communication with one of the base stations. Cellular telephony is implemented using standards such as GSM and CDMA (and other evolving standards such as W-CDMA, etc.).

Mobile phones store various types of information. As used in the present application, information represents data (as opposed to executable instructions), and include information types such as address book (having phone numbers and names of various people of interest), call logs (providing details of missed calls, received calls and dialed calls), and SMS logs (received SMS messages, sent SMS messages, not-yet-delivered messages, etc.).

There is a general need for remotely accessing information stored on mobile phones. Remote access implies that the information is accessible at locations distant from where a mobile phone is located at that time instance.

### BRIEF DESCRIPTION OF THE DRAWINGS

Example embodiments of the present invention will be described with reference to the accompanying drawings briefly described below.

FIG. 1 is a block diagram illustrating an example environment in which several aspects of the present invention can be implemented.

FIG. 2 is a flowchart illustrating the manner in which remote access to information stored in a mobile phone is provided, in an embodiment of the present invention.

FIG. 3 is block diagram illustrating some of the relevant internal blocks of a mobile phone, in an embodiment of the present invention.

FIG. 4 is block diagram illustrating some of the relevant internal blocks of a server system, in an embodiment of the present invention.

FIG. 5 is a block diagram illustrating the details of a digital processing system in which various aspects of the present invention are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

1. Overview

A device, accessible by a network interfacing based on cellular telephony, receives an SMS (short messaging service) message, and in response causes information stored on a mobile phone to be transmitted to a server system. A user can thereafter access the data by interfacing with the server system using protocols such as IP (Internet).

In an embodiment, the device is the mobile phone, which on receipt of the SMS message initiates transmission of the data to a server system (from which the transferred data is accessible).

In another embodiment, the device is a server system, which initiates communication with the mobile phone to cause the data to be transferred (to the server system).

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

2. Example Environment

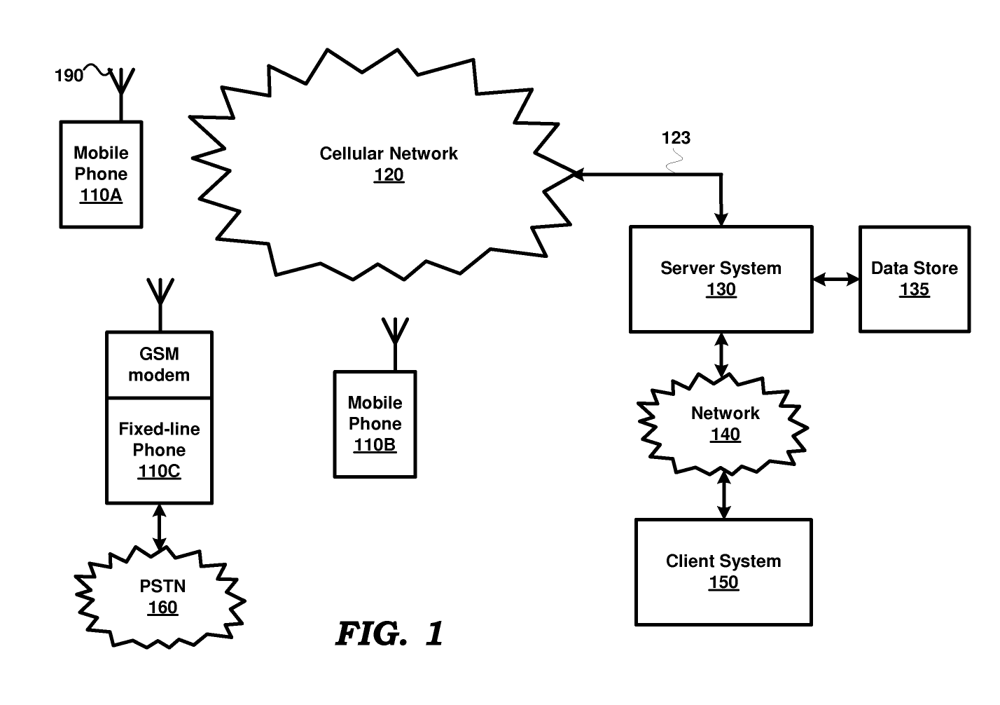

FIG. 1 is a block diagram illustrating an example environment in which several aspects of the present invention can be implemented. The diagram is shown containing mobile phones 110A and 110B, fixed-line phone 110C, cellular network 120, server system 130, data store 135, network 140, client system 150, and public switched telephone network (PSTN or POTS) 160.

Merely for illustration, only representative number/type of devices and systems are shown in FIG. 1. Many environments often contain many more systems, both in number and type, depending on the purpose for which the environment is designed. Each block of FIG. 1 is described below in further detail.

Cellular network 120 enables mobile devices such as mobile phones to communicate with each other. Cellular network 120 is typically a distributed network organized as ‘cells’, with each cell representing a corresponding geographical area served by one or more base stations. The base stations operate to facilitate communication (connecting calls, forwarding or sending SMS messages, etc.) between mobile phones within coverage area of cellular network 120. Cellular network 120 may also provide connectivity with other cellular networks, the internet, as well as with conventional wireline infrastructure of a PSTN network. Cellular network 120 may be designed consistent with corresponding technologies and standards, examples of which include GSM and CDMA.

Mobile phone 110A allows a user (of mobile phone 110A) to send and receive voice calls and SMS (short messaging service) messages to and from other phones (mobile phones, wireline phones, and communication terminals in general) via cellular network 120 (with the corresponding base stations being the first and last hop in the respective direction of the communication). Mobile phone 110A contains internal memory for storing names, addresses, phone numbers, etc. (in general, ‘contact information’ organized, for example, in the form of an ‘address book’) of persons, and maintains call logs and SMS logs. The entries in the address book and the logs stored in mobile phone 110A represent data (as contrasted from executable applications that enable the features provided by mobile phone 110A). In addition, based on the specific capabilities implemented in mobile phone 110A, mobile phone 110A may also provide features such as sending and receiving of electronic mail (email) based on WiFi/Internet Protocol, as well as SMS messages using GPRS (General Packet Radio Service) technology. Mobile phone 110A may be implemented consistent with the interface requirements of cellular network 120.

Mobile phone 110B may be implemented similar to mobile phone 110A. Fixed-line phone 110C is connected to PSTN 160. Fixed-line phone 110C contains a GSM modem (or CDMA modem depending on the technology used to implement cellular network 120), thereby allowing SMS messages to be sent/received from/at fixed-line phone 110C via cellular network 120. PSTN 160 provides wireline connectivity to telephones and other wireline communication equipment connected to it. Although shown separate from network 140, it will be understood that some or all of network 140 may be built on the infrastructure (telephone lines, etc.) provided by PSTN 160.

Server system 130 represents a server, such as a web/application server, capable of performing tasks (e.g., processing requests) requested by users using a client system, such as client system 150 described below. Server system 130 may use data in data store 135 or data received from external sources in performing such tasks. Server system 130 then sends the result of performance of the tasks to the requesting client system (client system 150, for example). Server system 130 may be connected with network 140 by a wired or wireless medium. Mobile phone 110A/B may also similarly be able to access server system using protocols such as IP.

Data store 135 stores data used by server system 130. The connection between server system 130 and data store 135 can be a simple wired path, or provided using technologies such as a local area network (LAN).

Network 140 provides connectivity between server system 130 and client system 150. In an embodiment, network 140 corresponds to the world-wide web or internet. Network 140 may be implemented to operate using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the target system to which the packet is to be eventually delivered. A packet is said to be directed to a target system when the destination address (phone number in case of telephone calls and SMS, and IP address in case of Internet Protocol) of the packet is set to the address of the target system, such that the packet is eventually delivered to the target system (by network 140 or cellular network, depending on the underlying technology). In case of TCP/IP packets, when the packet contains content such as port numbers, which specifies the target application, the packet may be said to be directed to such application as well. Although not indicated in FIG. 1, direct communication connection (via appropriate gateways) may be present between network 140 and cellular network 120 as well.

Client system 150 represents a system such as a personal computer, workstation, etc., used by end users to generate (user) requests directed to server system 130. The requests may be generated using appropriate user interfaces (e.g., in a web browser executing on client system 150). In general, client system 150 requests an application (in server system 130) for performing desired tasks and receives corresponding responses containing the results of performance of the requested tasks. Each request may be sent in the form of an IP packet directed to server system 130, with the IP packet including data identifying the desired tasks in the payload portion.

In an embodiment, the systems of FIG. 1 are designed to facilitate remote access of information stored on mobile phone 110A. For example, a user of client system 150 may be provided access to data such as contact information, call logs and SMS logs stored in mobile phone 110A. Such facility may be desirable, for example, when a user/owner of a mobile phone does not currently have the phone (an example is when the user forgets to carry the phone with him), but wishes to access such data stored in the phone.The manner in which such remote access is provided is described next with examples.

3. Providing Remote Access

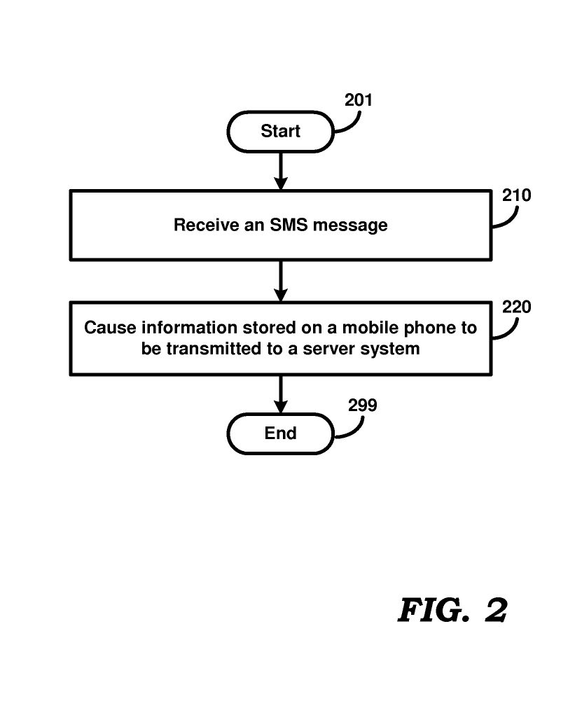

FIG. 2 is a flowchart illustrating the manner in which remote access to information stored in a mobile phone is provided, in an embodiment of the present invention. The flowchart is described with respect to the blocks of FIG. 1 merely for illustration. However, many of the features can be implemented in other environments also without departing from the scope and spirit of several aspects of the present invention, as will be apparent to one skilled in the relevant arts by reading the disclosure provided herein. The flow chart begins in step 201, in which control immediately passes to step 210.

In step 210, a device (article of manufacture, in general), accessible by a network interface based on cellular telephony, receives an SMS message. A network interface based on cellular telephony refers to an interface that enables the device to communicate directly (single-hop) with a cellular network (specifically base stations therein), without having to be routed through other networks (wired or wireless). The target/recipient address of the SMS message received by the device is the phone number (having globally unique number based on country code, etc.) of the device, and uniquely identifies the device. As is well known in the relevant arts, SMS (Short Message Service) is a text messaging service that provides exchange of short text messages between fixed-line or mobile phone devices. SMS is supported currently both by GSM and CDMA-based cellular standards and GPRS technology. Control then passes to step 220.

In step 220, the device, in response to receiving the SMS of step 210, causes information stored on a mobile phone to be transmitted to server system 130. Any necessary action (according to any pre-specified convention) may be performed to cause transmission of information to server system 130. Server system 130 may either store the information, or forward the information to some other system for storage and/or viewing. Control then passes to step 299, in which the flowchart ends.

The operations of the flowchart described above are illustrated with additional examples below.

4. Example Illustrations

In one embodiment (hereafter referred to as ‘Embodiment A’), the device of the flowchart of FIG. 2 is mobile phone 110A. Assuming the owner or user of mobile phone 110A does not have the phone with him, but wishes to access data stored in mobile phone 110A, the owner/user sends an SMS to mobile phone 110A (step 210) from another phone such as mobile phone 110B or fixed-line phone 110C. The SMS to mobile phone 110A has a target address (the phone number) uniquely identifying mobile phone 110A, and is thus delivered to mobile phone 110A via cellular network 120.

The SMS has content in the payload, according to a pre-specified convention, to indicate that the information/ data (stored in mobile phone 110A) is to be transmitted to server system 130. According to one convention, an identifier or a control code (authentication data, in general) contained in the body of the SMS indicates that the SMS is a directive/instruction to mobile phone 110A to transfer data to server system 130. Mobile phone 110A compares the authentication data in the payload of the SMS with a pre-determined (and pre-stored) data to determine validity of the authentication data.

As an example, the identifier can be the IMEI (International Mobile Equipment Identity) number of mobile phone 110A. The IMEI is deemed to be an authorization or authentication to effect transfer of data to server system 130. Thus, the identifier also enables mobile phone 110A to determine if the received SMS is a ‘valid’ request for transfer of data from mobile phone 110A to server system 130. It should however be appreciated that more complex conventions (in the content of the SMS) can be employed to instruct and/or authenticate the request via the SMS.

In response to receiving the SMS, mobile phone 110A transmits data such as the stored address book, call log and SMS log to server system 130 (step 220). Mobile phone 110A may accordingly be implemented with the corresponding software application which initiates communication with server system 130, and then transmits the data to server system 130. In an embodiment, mobile phone 110A establishes communication with server system 130 using the HTTP protocol, and then transmits the data. Mobile phone 110A may be configured with the IP address (or URL type unique identifier) of server system 130, to be able to initiate communication with server system 130 using IP technology. Technologies such as SyncML can be used (in combination with IP) for transmission of the data to server system 130. SyncML (Synchronization Markup Language) is a synchronization standard relating to techniques for synchronizing contact and calendar information between handheld devices (such as a mobile phone) and a computer (personal or network-based). Once the data has been transferred to server system 130 (and optionally stored in data store 135), a user may view and record/store by accessing server system 130 using client system 150. The user can also reply to SMS messages and voice calls logged in the SMS log and call log, accessed from server system 130. The user can also choose to delete the data from server system 130.

In another embodiment (hereafter ‘Embodiment B’), the device of the flowchart of FIG. 2 is server system 130 itself. Thus, a user who wishes to access data stored in mobile phone 110A, sends an SMS to server system 130 (step 210) from another phone such as mobile phone 110B or fixed-line phone 110C. The payload of the SMS may contain the phone number of mobile phone 110A (indicating that the information in mobile phone 110A is to be transferred). The payload may also contain authentication information (e.g., IMEI, as explained above).

In response to receiving the SMS (from phone 110B or 110C), server system 130 sends another SMS to mobile phone 110A (having content similar to that described in Embodiment A, along with any authentication information such IMEI) instructing mobile phone 110A to transmit stored information back to server system 130 (step 220). Mobile phone 110A then transmits the requested information to server system 130 in a manner similar to that described above with respect to Embodiment A. In an embodiment, server system 130 executes instruction modules designed according to the SyncML standard, noted above. Mobile phone 110A is loaded with the corresponding components to enable synchronization of data between server system 130 and mobile phone 110A. However, in other embodiments, other techniques may be employed on server system 130 and mobile phone 110A to facilitate transfer of data stored in mobile phone 110A to server system 130. As in Embodiment A, the user can also reply to SMS messages and voice calls logged in the SMS log and call log, accessed from server system 130. The user can also choose to delete the data from server system 130.

With the above-described techniques, there is no requirement for server system 130 to continuously (or intermittently) request for data from mobile phone 110A, and store such data. Instead, transfer of such data and subsequent storage in server system 130 occurs only upon triggering by an SMS, and hence is under control of the user, thereby potentially reducing storage requirements in server system 130.

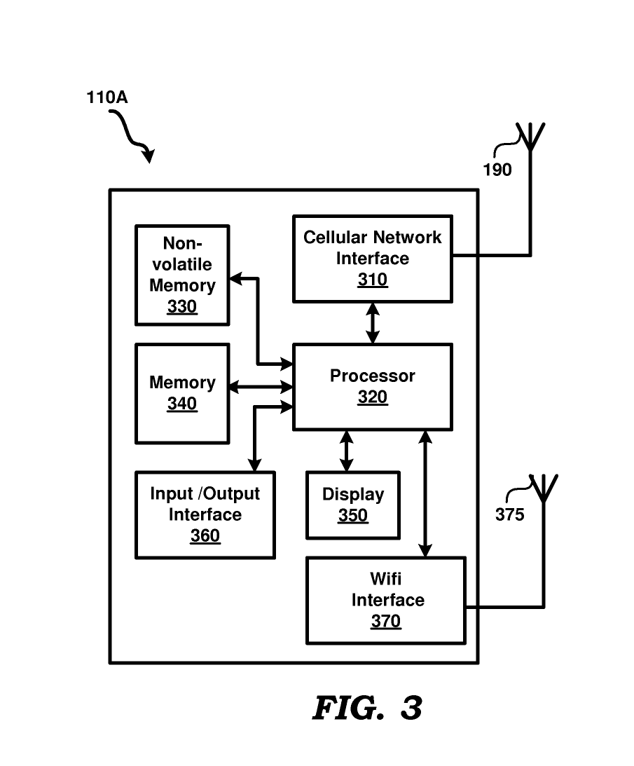

FIG. 3 is block diagram illustrating some of the relevant internal details of mobile phone 110A, in an embodiment. Mobile phone 110A is shown containing antenna 190, cellular network interface 310, processor 320, non-volatile memory 330, memory 340, display 350, input interface 360 and WiFi interface 370. The blocks of FIG. 3 are shown merely by way of example, and other embodiments may contain more or fewer blocks.

Antenna 190 transmits signals to and receives signals from cellular network 120 (FIG. 1) via a wireless medium, enabling mobile phone 110A to make and receive voice calls, send/receive SMS messages etc., wirelessly.

Cellular network interface 310 receives RF (radio frequency) signals from antenna 190, processes the signals to extract information (digitized voice, data representing SMS messages, signaling information such as call setup information, etc.) and provides the extracted information to processor 320. Cellular network interface 310 receives, from processor 320, data representing digitized voice, messages (SMS), web browsing data, etc., and generates corresponding RF signals for transmission via antenna 190. In case of Embodiment A noted above, cellular network interface 310 represents the network interface based on cellular telephony, noted above with respect to step 210.

Processor 320 executes instructions to enable the various features provided in mobile phone 110A. The features include processing data representing voice calls and SMS messages, and coordinating with cellular network interface 310 and the other blocks of FIG. 3 to enable a user to send and receive voice calls and SMS messages. Processor 320 stores (for example, under user control via input/output interface 360) address book(s) containing names, telephone numbers, addresses, etc., of persons, as well as call logs and message logs in non-volatile memory 330.

Non-volatile memory 330 stores address books, call logs and message logs. In addition, non-volatile memory 330 stores instructions for execution by processor 320, including the instructions to enable mobile phone 110A to operate as described with respect to the flowchart of FIG. 2. With respect to Embodiment A noted above, such instructions include those that would cause mobile phone 110A to receive an SMS message, examine the corresponding payload for any required authentication/instruction, and thereafter initiate communication with server system 130 (either using cellular network interface 310 and antenna 190, or WiFi interface 370 and antenna 375) to cause the information to be transmitted to server system 130. In case of Embodiment B, the instruction may merely need to accept a request (e.g., again in the form of a SMS, as noted above) from server system 130 for transmission of data, and thereafter cooperatively transmit the data to server system 130.

Memory 340 is used for temporary storage of instructions and/or data operated on by processor 320, and is typically implemented as a RAM (random access memory). WiFi interface 370 operates in accordance with WLAN (802.11 family of standards) to provide wireless communication via antenna 375 with access points and/or other wireless devices, such communication forming the basis for Internet Protocol (IP)-based communication over network 140. The transfer of information stored in mobile phone 110A to server system 130 may be based on such wireless communication.

Input/Output interface 360 enables a user of mobile phone 110A to provide inputs (e.g., text and numeric data via a keypad, or speech/audio via a microphone) to mobile phone 110A, and receive outputs (e.g., speech/audio via a speaker) from mobile phone 110A. Display 350 provides a visual user interface to a user.

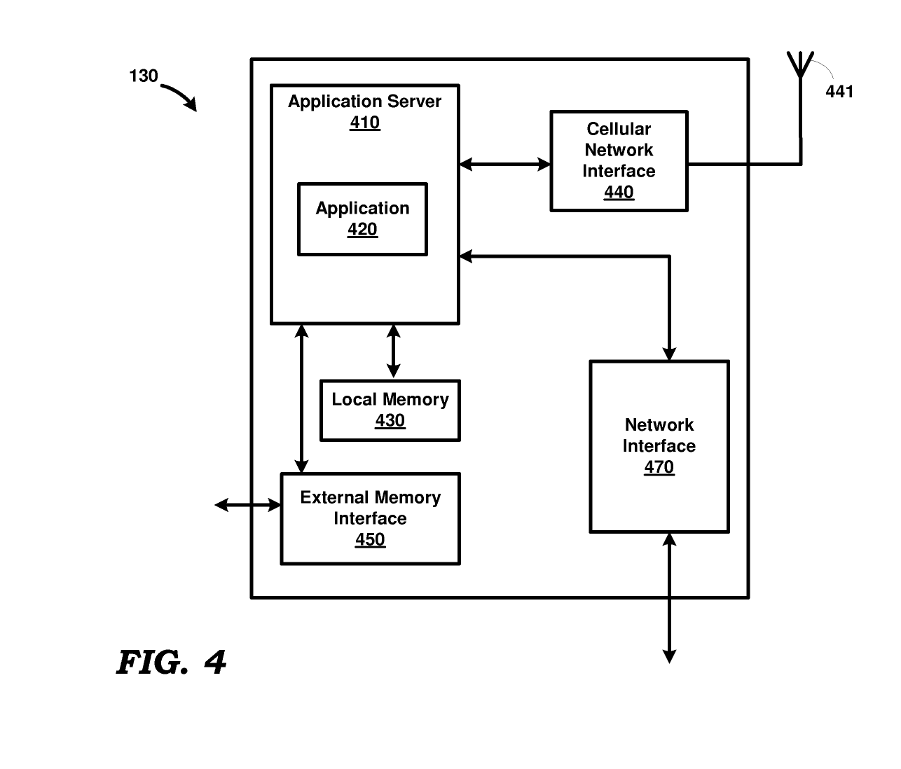

FIG. 4 is block diagram illustrating some of the relevant internal details of server system 130, in an embodiment. Server system 130 is shown containing application server 410, local memory 430, cellular network interface 440, external memory interface 450, and network interface 470. The blocks of FIG. 4 are shown merely by way of example, and other embodiments may contain more or fewer blocks.

Cellular network interface 440 enables server system 130 to send RF signals to and received RF signals from cellular network 120 via antenna 441. With respect to Embodiment B noted above, cellular network interface 440 enables servers system 130 to receive SMS messages from mobile phone 110B (or fixed line phone 110C), and in response to send another SMS message to mobile phone 110A for causing transfer of information stored in mobile phone 110A. In case of Embodiment B, cellular network interface 440 represents the network interface based on cellular telephony, noted above with respect to step 210.

Network interface 470 provides connectivity to network 140 (e.g., using Internet Protocol), and enables communication between server system 130 and other systems such as client system 150 of FIG. 1. The communication can be the basis for transferring (or retrieving) the information from mobile phone 110A (to local memory 430) as described above, as well as to provide access to such stored information to client systems (e.g., 150).

External memory interface 450 enables application server 410 to store and retrieve data from an external storage device such as data store 135 of FIG. 1. Local memory 430 is used for storing instructions (for e.g., those representing application 420) as well as data locally (i.e., within server system 130). Local memory 430 contains a non-volatile memory (to store the transferred information), but may also additionally include volatile memory such as RAM (to facilitate execution of instructions).

Application server 410 is shown executing application 420. Application 420 performs at least some of the operations noted above with respect to server system 130. Thus, for example, application 420 may receive data stored in mobile phone 110A, and store the data either locally in local memory 430 or in data store 135 via external memory interface 450. On receiving a request from a user of client system 150 (after appropriate authentication), application 420 forwards the data received earlier from mobile phone 110A (and stored locally) to client system 150 via network interface 470.

The description is continued with respect to a digital processing system in which various features are operative when the corresponding executable modules are executed.

5. Digital Processing System

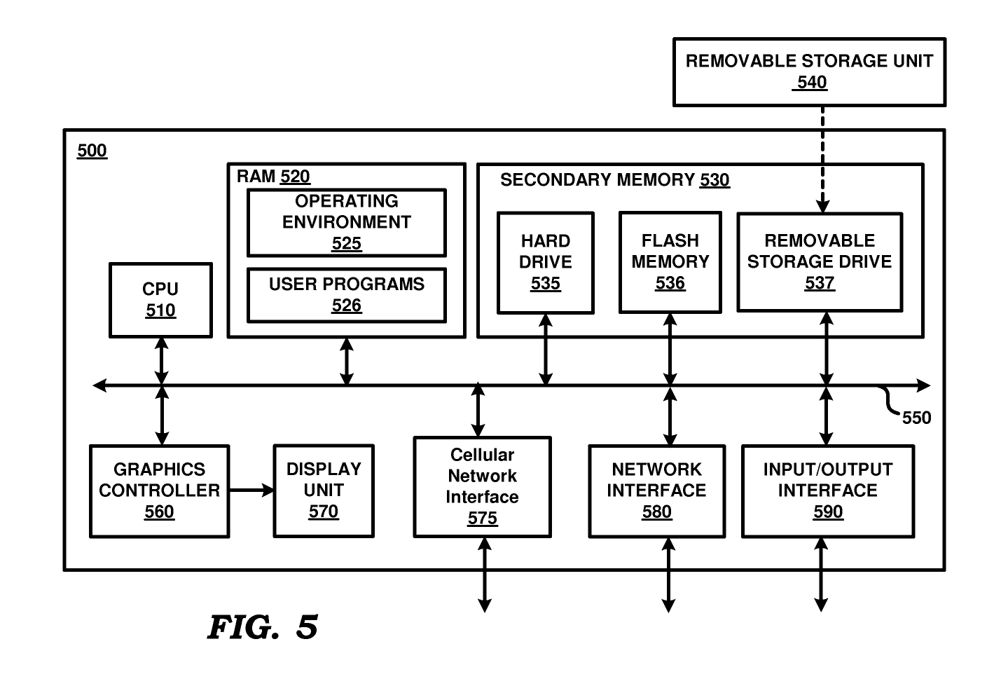

FIG. 5 is a block diagram illustrating the details of digital processing system 500 in which various aspects of the present invention are operative by execution of appropriate executable modules. Digital processing system 500 may correspond to either server system 130 or mobile phone 110A, and executes the corresponding instructions to enable remote access of information stored on a mobile phone.

Digital processing system 500 may contain one or more processors (such as a central processing unit (CPU) 510), random access memory (RAM) 520, secondary memory 530, graphics controller 560, display unit 570, cellular network interface 575, network interface 580, and input/output interface 590. All the components except display unit 570 may communicate with each other over communication path 550, which may contain several buses as is well known in the relevant arts.

CPU 510 may execute instructions stored in RAM 520 to provide several features of the present invention. CPU 510 may contain multiple processing units, with each processing unit potentially being designed for a specific task. Alternatively, CPU 510 may contain only a single general-purpose processing unit. When system 500 represents mobile phone 110A, CPU 510 corresponds to processor 320 of FIG. 3. When system 500 represents server system 130, CPU 510 include the processor (or set of processors) contained within application server 410, and which execute(s) application 420.

RAM 520 may receive instructions from secondary memory 530 using communication path 550. RAM 520 is shown currently containing software instructions constituting shared environment 525 and/or user programs 526 (which include application 420 of FIG. 4 when system 500 represents server system 130). Shared environment 525 contains utilities shared by user programs, and such shared utilities include operating system, device drivers, etc., which provide a (common) run-time environment for execution of user programs/applications.

Graphics controller 560 generates display signals (e.g., in RGB format) to display unit 570 based on data/instructions received from CPU 510. Display unit 570 contains a display screen to display the images defined by the display signals, and corresponds to display 350 when system 500 represents mobile phone 110A. Input/output interface 590 includes input as well as output devices to enable a user to interact with system 500, and corresponds to input/output interface 360 of FIG. 3.

Network interface 580 corresponds to network interface 470 of FIG. 4 when system 500 represents server system 130, and to WiFi interface 370 when system 500 represents mobile phone 110A. Cellular network interface 575 corresponds to one of cellular network interface 310 of FIG. 3 or cellular network interface 440 of FIG. 4, depending on whether system 500 represents mobile phone 110A or server system 130.

Secondary memory 530 (representing a non-transitory storage/medium) may contain hard drive 535, flash memory 536, and removable storage drive 537. Secondary memory 530 may store data and software instructions (for example, for performing the steps of FIG. 2), which enable digital processing system 500 to provide several features in accordance with the present invention. Secondary memory 530 corresponds to one of non-volatile memory 330 of FIG. 3 or local memory 430 of FIG. 4, depending on whether system 500 represents mobile phone 110A or server system 130.

Some or all of the data and instructions may be provided on removable storage unit 540, and the data and instructions may be read and provided by removable storage drive 537 to CPU 510. Floppy drive, magnetic tape drive, CD-ROM drive, DVD Drive, Flash memory, removable memory chip (PCMCIA Card, EPROM) are examples of such removable storage drive 537.

Removable storage unit 540 may be implemented using medium and storage format compatible with removable storage drive 537 such that removable storage drive 537 can read the data and instructions. Thus, removable storage unit 540 includes a computer readable storage medium having stored therein computer software and/or data. However, the computer (or machine, in general) readable storage medium can be in other forms (e.g., non-removable, random access, etc.).

In this document, the term “computer program product” is used to generally refer to secondary memory 530. These computer program products are means for providing software to digital processing system 500. CPU 510 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

6. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method of providing access to information stored on a first mobile phone, said method being performed in a device accessible by a network interface based on cellular telephony, said method comprising:
receiving, in said device, an SMS (short messaging service) message using a cellular network; and
in response to receiving of said SMS, causing said information stored on said first mobile phone to be transmitted to a server system.

2. The method of claim 1, wherein said information comprises data representing at least a portion of one of address book, call logs, and SMS logs stored on said first mobile phone.

3. The method of claim 2, wherein said information, after being transmitted to said server system, is accessible to client systems over a network based on Internet Protocol.

4. The method of claim 3, wherein said first mobile phone comprises said device, wherein said SMS message originates in a second mobile phone and is directed to said first mobile phone, wherein said first mobile phone, in response to receiving of said SMS, initiates communication with said server system to transfer said information to said server system.

5. The method of claim 3, wherein said server system comprises said device, wherein said SMS message originates in a third mobile phone and is directed to said server system, said SMS message indicating that information from said first mobile phone is to be transmitted to said server system,
wherein said server system, in response to receiving said SMS message, sends another SMS message using a cellular network to said first mobile phone,
wherein said first mobile phone in response to said another SMS message, transfers said information to said server system.

6. The method of claim 3, wherein said SMS message contains an authentication data, said method further comprising:
comparing said authentication data to a pre-determined data according to a convention,
wherein said information is caused to be transmitted to said server system only when said authentication data matches said pre-determined data.

7. The method of claim 6, wherein said authentication data contains International Mobile Equipment Identity (IMEI) number of said first mobile phone.

8. A machine readable medium carrying one or more sequences of instructions for execution by one or more processors in a device accessible by a network interface based on cellular telephony for enabling remote access to information stored on a first mobile phone, wherein execution of said one or more sequences of instructions by said one or more processors causes said device to perform the actions of:
receiving an SMS (short messaging service) message using a cellular network; and
in response to receiving of said SMS, causing said information stored on said first mobile phone to be transmitted to a server system.

9. The machine readable medium of claim 8, wherein said information, after being transmitted to said server system, is accessible to client systems over a network based on Internet Protocol.

10. The machine readable medium of claim 8, wherein said information comprises data representing at least a portion of one of address book, call logs, and SMS logs stored on said first mobile phone.

11. The machine readable medium of claim 10, wherein said first mobile phone comprises said device, wherein said SMS message originates in a second mobile phone and is directed to said first mobile phone,
wherein said first mobile phone, in response to receiving of said SMS, initiates communication with said server system to transfer said information to said server system.

12. The machine readable medium of claim 11, wherein said server system comprises said device, wherein said SMS message originates in a third mobile phone and is directed to said server system, said SMS message indicating that information from said first mobile phone is to be transmitted to said server system,
wherein said server system, in response to receiving said SMS message, sends another SMS message using a cellular network to said first mobile phone,
wherein said first mobile phone in response to said another SMS message, transfers said information to said server system.

13. The machine readable medium of claim 11, wherein said SMS message contains an authentication data, said device to compare said authentication data to a pre-determined data according to a convention,
wherein said information is caused to be transmitted to said server system only when said authentication data matches said pre-determined data.

14. The machine readable medium of claim 13, wherein said authentication data contains International Mobile Equipment Identity (IMEI) number of said first mobile phone.

15. A digital processing system comprising:
a processor; and
a machine readable medium storing one or more sequences of instructions,
wherein execution of said one or more sequences of instructions by said processor causes said processor to perform the actions of:
receiving, in said digital processing system, an SMS (short messaging service) message using a cellular network; and
in response to receiving of said SMS, causing said information stored on a first mobile phone to be transmitted to a server system.

16. The digital processing system of claim 15, wherein said information comprises data representing at least a portion of one of address book, call logs, and SMS logs stored on said first mobile phone.

17. The digital processing system of claim 16, wherein said information, after being transmitted to said server system, is accessible to client systems over a network based on Internet Protocol.

18. The digital processing system of claim 4415, wherein said first mobile phone comprises said digital processing system, wherein said SMS message originates in a second mobile phone and is directed to said first mobile phone,
wherein said first mobile phone, in response to receiving of said SMS, initiates communication with said server system to transfer said information to said server system.

19. The digital processing system of claim 17, wherein said server system comprises said digital processing system, wherein said SMS message originates in a third mobile phone and is directed to said server system, said SMS message indicating that information from said first mobile phone is to be transmitted to said server system,
wherein said server system, in response to receiving said SMS message, sends another SMS message using a cellular network to said first mobile phone,
wherein said first mobile phone in response to said another SMS message, transfers said information to said server system.

20. The digital processing system of claim 17, wherein said SMS message contains an authentication data, wherein said processor is further operable to compare said authentication data to a pre-determined data according to a convention,
wherein said information is caused to be transmitted to said server system only when said authentication data matches said pre-determined data.
